(19) United States
(12) Patent Application Publication
(10) Pub. No.: US 2025/0111778 A1
(43) Pub. Date: Apr. 3, 2025

(54) DEVICES, SYSTEMS AND METHODS FOR ADJUSTING VEHICLE SYSTEMS WHEN APPROACHING A ROAD EVENT, INCLUDING A HAZARD EVENT

(71) Applicant: Cypress Semiconductor Corporation, San Jose, CA (US)

(72) Inventors: Bradley EVANS, Northville, MI (US); Nicholas Stopher, White Lake, MI (US)

(21) Appl. No.: 18/477,738

(22) Filed: Sep. 29, 2023

(51) Int. Cl. G08G 1/0968; B60W 10/06; B60W 10/08; B60W 10/184; B60W 10/22; B60W 30/02; B60W 30/14; B60W 50/14; H04W 4/40; H04W 4/80

(52) U.S. Cl. CPC G08G 1/096833; B60W 10/184; B60W 30/02; B60W 30/143; B60W 50/14; G08G 1/096855; B60W 10/06; B60W 10/08; B60W 10/22; B60W 2552/00; B60W 2555/20; B60W 2756/10; H04W 4/40; H04W 4/80

(57) ABSTRACT

A method can include by operation of wireless circuits of a vehicle, wirelessly receiving event data, including an event location; by operation of processing circuits of the vehicle, determining when the vehicle is within a predetermined proximity of the event location; in response to the vehicle being within proximity of the event location, automatically adjusting at least one system of the vehicle according to at least the event data. In response to the vehicle moving beyond the event location, the at least one system can be returned to a previous state or readjusted. Corresponding devices and systems are also disclosed.

### TECHNICAL FIELD

The present disclosure relates generally to vehicle systems, and more particularly to vehicle systems for automatically adjusting vehicle systems prior to encountering a road event, such as a road hazard.

### BACKGROUND

Conventional vehicles, as well as user devices such as smartphones, can include vehicle mapping services. Mapping services can be deployed on remote computing systems to provide location information and other features such as route calculation and searches for local services (e.g., restaurants, business, fuel locations, etc.). Updated mapping data can then be provided to vehicles and/or user devices.

Some mapping services can access road alert services that provide alerts for geographic regions. Road alert services can use reports from public and private institutions, such as law enforcement, emergency services (e.g., firefighters/paramedics, ambulance) and towing companies to locate and identify road events. In addition, some road alert services can use reports called in by trusted individuals. Such road alerts can be included in updates to mapping data.

### SUMMARY OF DISCLOSURE

Embodiments can include wireless circuits of a vehicle receiving event data, which can include an event location. Processing circuits of the vehicle can determine when the vehicle is within a predetermined proximity of the event location. In response to the vehicle being within proximity of the event location, one or more systems of a vehicle can be adjusted based on the event data. In response to the vehicle moving beyond the event location, systems of a vehicle can be returned to previous states or readjusted.

In some embodiments, event data can include an event type. Processing circuits can generate system settings in response to the event type. The system settings can adjust systems of the vehicle.

In some embodiments, a remote system can accumulate event reports from other vehicles. The event reports can be analyzed to determine a location and type of event. The remote system can wirelessly transmit event data to the vehicle, which can adjust its system settings in response to the event data.

### BRIEF DESCRIPTION OF THE DRAWINGS

FIG. 1 is a diagram showing a system for generating vehicle system settings in response to an approaching road event according to an embodiment.

FIG. 2 is a flow diagram of a method for adjusting vehicle system settings when a road hazard zone, according to an embodiment.

FIG. 3 is a block schematic diagram of a vehicle system according to an embodiment.

FIG. 4 is a diagram showing vehicle system setting data generated according to an embodiment.

FIG. 5 is a flow diagram of a method for generating event notices according to an embodiment.

FIGS. 6A and 6B are diagrams showing controller devices according to embodiments.

FIG. 7 is a flow diagram of method according to an embodiment.

FIG. 8 is a block diagram of a remote computing system according to an embodiment.

FIG. 9 is a diagram showing map/routing data with event notice data according to embodiments.

FIG. 10 is a flow diagram of a method according to another embodiment.

FIGS. 11A and 11B are diagrams showing machine learning systems according to embodiments.

### DETAILED DESCRIPTION

According to embodiments, a vehicle can wirelessly receive an event notification, which can identify a location of an event. As the vehicle approaches the location of the event, processing circuits can adjust system settings in the vehicle to aid in encountering the event. After passing the event location, the vehicle system settings can be returned to previous values and/or adjusted to current conditions.

According to embodiments, an event notification can identify a type of event. Adjustments to vehicle systems can be tailored to the type of event. In some embodiments, an event notification can also indicate event severity, and system settings can be further tailored to the severity of event.

According to embodiments, an event notification can be generated by a remote system that collects event reports from other vehicles. From such event reports, a remote system can determine an event type, event location and event severity. Such event data can then be transmitted to a target vehicle in a same geographic area as the event.

In some embodiments, a processing circuits of a vehicle system can generate system settings from data within an event notification.

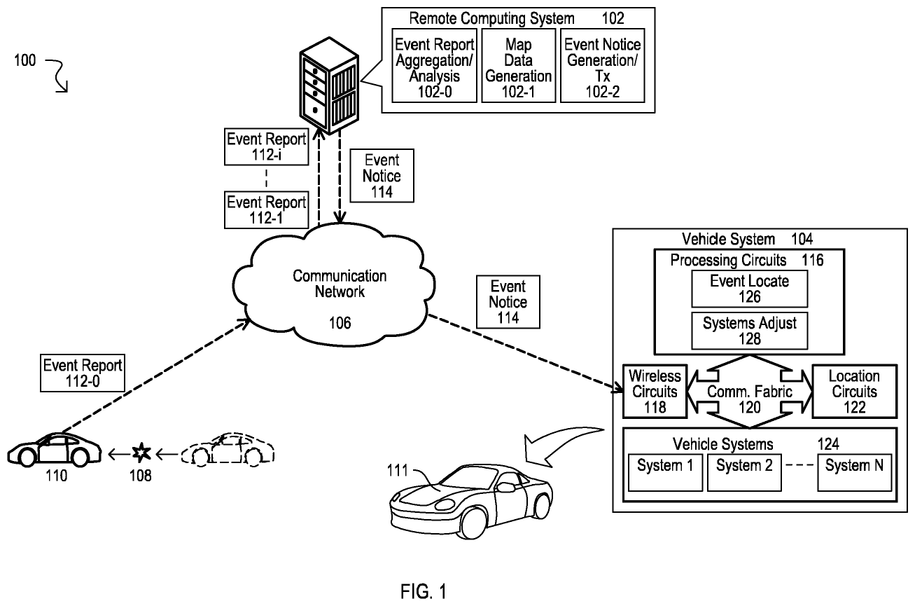

FIG. 1 is a diagram of a system 100 according to an embodiment. A system 100 can include a remote computing system 102 and a vehicle system 104. Other vehicles (e.g., 110) can be traveling and encounter a road event 108, which can be a hazardous condition, as but one example. In response to the road event 108, another vehicle 110 can generate an event report 112-0. In some embodiments, an event report 112-0 can include sensor data generated by the vehicle 110. Event reports (112-0 to 112-i) from other vehicles can be transmitted wirelessly over a communications network 106 to remote system 102. A communications network 106 can enable communications between vehicles and a remote system, and can include any suitable network, including a cellular network, the internet, a WLAN, a WAN, LAN, private network, or combinations thereof.

A remote computing system 102 can include one or more server systems running one or more applications that can process event reports (112-0 to -i). Such an application can determine the presence of road events (including conditions) at a geographic location/area, and report such an event to other vehicles approaching or otherwise in proximity to the event location. A remote computing system 102 can execute a number of operations, including but not limited to, event report aggregation and/or analysis 102-0, map data generation 102-1 and event notice generation and transmission 102-2. Event report aggregation/analysis 102-0 can collect event reports (112-0 to -i) from other vehicles, and from such data determine any of: the existence of an event, the location of the event, the type of event, and whether such an event is to be reported to other vehicles (e.g., is of sufficient severity). Map data generation 102-1 can include generating map data for an event that is to be reported. Such an operation can include, but is not limited to, determining global positioning system (GPS) coordinates for the event, a proximity (e.g., warning distance) for the event, and/or data formatting for various mapping systems employed by vehicles receiving event notices. Event notice generation and transmission 102-2 can include creation of an event notice packet 114 packet according to one or more wireless standards, and transmitting such a packet with appropriate addressing to target vehicle(s) 111. In the embodiment shown, an event notice 114 packet can be transmitted to a target vehicle 111 over a same communications network 106 that relays event reports (112-0 to -i). However, in alternate embodiments event notices 114 can be relayed over one or more different networks than those carrying event reports (112-0 to -i).

In some embodiments, event reports (112-0 to 112-i) can be periodically generated regardless of sensor readings or variance. Analysis (e.g., 102-0) of such (non-adverse) event reports can indicate a condition of the road. Such road condition data can indicate good conditions for driving, or can be used to report rougher roads to signal that maintenance may be needed.

A vehicle system 104 can be a system resident on a target vehicle 111. A vehicle system 104 can include processing circuits 116, wireless circuits 118, location circuits 122 and vehicle systems 124 in communication with one another over a communication fabric 120. Wireless circuits 118 can receive event notices 114. Wireless circuits 118 can operate according to any suitable wireless standards that enables a target vehicle 111 to receive timely communications, including but not limited to cellular, satellite, one or more IEEE 802.11 wireless standards.

Processing circuits 116 can access or receive event notices, and in response execute an event location operation 126 and system adjustment operation 128. An event location operation 126 can use data from location circuits 122 to determine a location of an event indicated by event notice 114 relative to the current location of a target vehicle 111. In some embodiments, an event location operation 126 can determine when a target vehicle 111 is within a predetermined distance of an event. A system adjustment operation 128 can adjust vehicle systems 124 to enable a target vehicle 111 to better manage traveling through the event.

Location circuits 122 can determine a location of a target vehicle. Location circuits 122 can include, but are not limited to, geolocation circuits, such as circuits that use GPS signals, cellular network locating signals, or location services that rely on other standards or services, including private wireless networks, including satellite based networks.

Vehicle systems 124 can include any vehicle system that can be altered by system settings generated by a system adjust operation 128 of processing circuits 116. Vehicle systems 124 can include, but are not limited to, systems that can make or change physical operations of a target vehicle 111, as well as systems that do not physically change a vehicle state, such as sensors or the like.

A communication fabric 120 can include any suitable communication technology suitable for transmitting data between system components of a target vehicle. A communication fabric 120 can include wired connections (e.g., buses, point-to-point connections) as well as wireless connections.

In operation, a target vehicle system 104 can receive an event notice 114. Using data from the event notice 114, processing circuits 116 can determine a proximity to an event indicated by the event notice, with an event locate operation 126. Prior to arriving at the event location indicated by the event notice 114, processing circuits 116 can execute a system adjustment operation 128, which can adjust a vehicle into a state more suitable for the event. In some embodiments, all or selected of the vehicle systems can be adjusted automatically, and not involve user action.

In this way, a system can include a remote computing system that issues event notices to target vehicles, which enable the target vehicles to adjust vehicle settings prior to encountering the event.

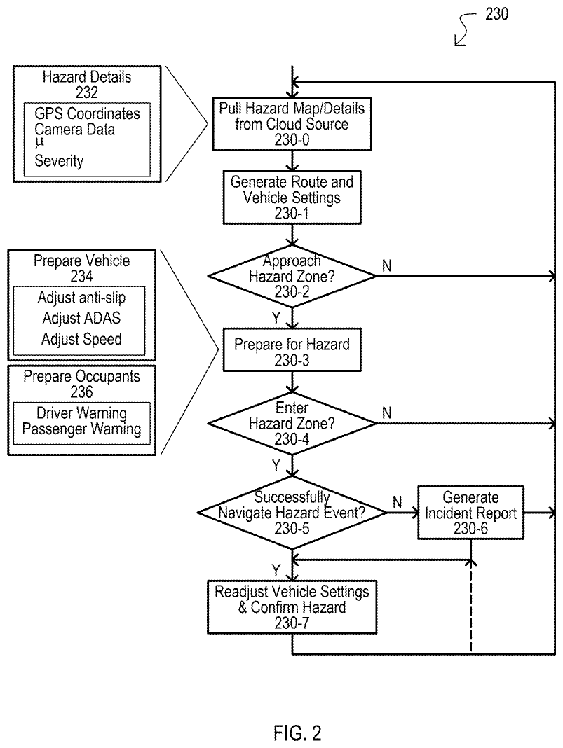

FIG. 2 is a flow diagram of a method 230 according to an embodiment. In some embodiments, a method 230 can be executed by a vehicle system. A method 230 can include pulling hazard map/details from a cloud source 230-0. Such an action can include receiving wireless transmissions, including but not limited to packetized data. In the embodiment shown, hazard details 232 can include, but are not limited to, any of: GPS coordinates, camera data, a traction related value (e.g., coefficient of friction, u) or severity of hazard. However, alternate embodiments can include other data as will be described herein. Embodiments can include a vehicle requesting hazard map/details from the cloud source and/or a vehicle periodically receiving hazard map/details from the cloud source.

A method 230 can include generating route and vehicle settings 230-1. Such an action can include a mapping application of a vehicle locating a hazard using received GPS coordinates for the hazard. Data values for various systems can be generated for input to vehicle systems to prepare a vehicle for a hazard. In some embodiments, vehicle setting values can vary according to hazard map/details received at 230-0.

A method 230 can determine when a hazard zone is approached 230-2. Such an action can include determining when a vehicle is within a certain range of a hazard indicated by actions of box 230-0. Such an action can include using GPS coordinates included in hazard details 232 and GPS coordinates of a vehicle. The point at which it is determined that a hazard zone has been approached can be based on any suitable factor, including distance to hazard, time to hazard and/or combinations thereof. The approach point for a hazard can vary. As but a few examples, such a point can be determined according to any of: hazard details 232, vehicle state (e.g., speed), or data related to the geographic location (e.g., road type, traffic conditions, indicated weather). In other embodiments, the approach point of a hazard can be a constant value that may or may not vary according to a type of hazard. If a hazard zone is not approached (N from 230-2), a method 230 can return to pulling hazard map/details 230-0.

If a hazard zone is approached (Y from 230-2), a method 230 can prepare a vehicle for the hazard 230-3. Such an action can include applying vehicle settings generated in 230-1 to a vehicle, and any other suitable actions that may assist a vehicle in traversing the hazard. In the embodiment shown, preparing for a hazard 230-3 can include preparing a vehicle 234 and/or preparing occupants 236. Preparing a vehicle 234 can include applying vehicle settings to adjust vehicle systems, including but not limited to: adjusting anti-slip systems, adjusting an advanced driver assistance system (ADAS) and/or adjusting a vehicle speed. Preparing occupants 236 can include generating a driver warning and/or passenger warning. It is understood that preparing for a hazard 230-3 can be executed in advance of encountering the hazard, as such an action is executed once a hazard zone has been approached. In some embodiments, a size of a hazard zone can vary according to the type of hazard. Also, a hazard zone can be measurement of distance, time or both.

A method 230 can determine if a hazard zone has been entered 230-4. Such an action can include any of the actions described for determining when a hazard zone is approached, but with smaller different time and/or distance values. If a hazard zone is not entered (N from 230-4), a method 230 can return to pulling hazard map/details 230-0.

If a hazard zone is entered (Y from 230-4), a method 230 can determine if the hazard was successfully navigated (230-5). Such an action can include a vehicle system monitoring sensors and/or a current location to determine if a hazard has adversely affected the vehicle. If it is determined that a hazard zone was not successfully navigated (N from 230-5), an incident report can be generated 230-6. Such an action can include a vehicle transmitting data to a system that includes data related to the hazard, including data prior to, during and after the hazard. In some embodiments, such an action can include generating and transmitting an event report as described herein (e.g., 112-0 in FIG. 1). In some embodiments, an incident report can be transmitted to a same cloud source from which hazard map/details are received.

If it is determined that a hazard zone was successfully navigated (Y from 230-5), a method 230 can readjust vehicle settings and confirm the hazard 230-7. Such an action can include returning vehicle settings to a state prior to approaching a hazard zone or changing vehicle setting based on current geographic location. A method 230 can then return to pulling hazard map/details 230-0. Optionally, after 230-7, a method can generate an incident report that confirms the hazard did not adversely affect the vehicle.

In this way, a method can include receiving hazard data from a cloud source, determine when a hazard is being approached, and prepare a vehicle and/or occupants for the hazard prior to entering a hazard zone.

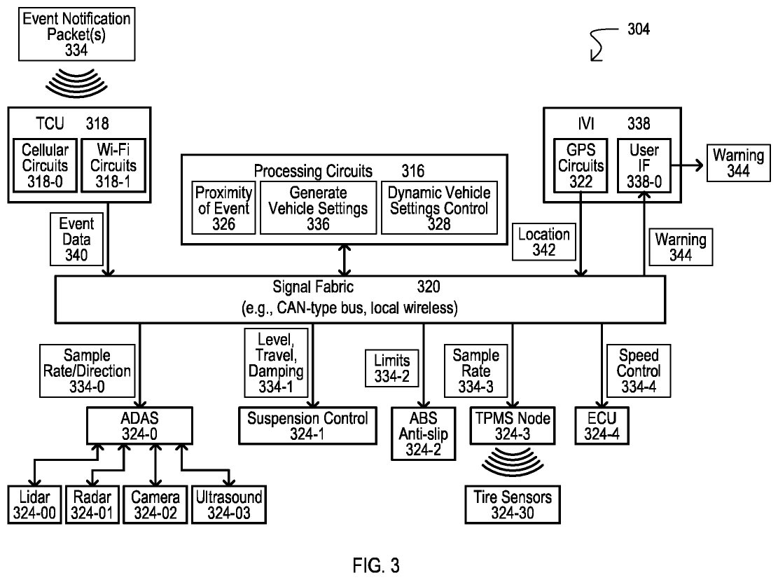

FIG. 3 is a block diagram of a vehicle system 304 according to an embodiment. A system 304 can include processing circuits 316 in communication with various systems over a signal fabric 320. The various systems can include a telematics control unit (TCU) 318, in-vehicle infotainment system (IVI) 338, ADAS 324-0, suspension control 324-1, anti-lock brake system (ABS) and/or anti-slip system 324-2, tire pressure monitoring system node (TPMS) 324-3 and engine/motor control unit (ECU) 324-4.

Processing circuits 316 can include circuits that execute various operations including but not limited to: determining a proximity of an event 326, generating vehicle settings 336, and dynamic vehicle settings control 328. Determining a proximity of an event 326 can include calculating a distance, time, or both, to an event. Generating vehicle settings 336 can include using data for an event to determine values for adjusting or otherwise configuring various systems (324-0 to -4) of a vehicle. Dynamic vehicle settings control 328 can send control signals/values to systems (324-0 to -4) to configure them for an event, and then following the event, send control signals/values to systems (324-0 to -4) that can return a vehicle to a previous state, or to a state best suited for the current (i.e., non-event) conditions.

A TCU 318 can enable wireless communications with a system 304, and can include any suitable wireless circuits, including but not limited to, cellular circuits 318-0 and circuits compatible with one or more IEEE 802.11 wireless standards or related standards, such as Wi-Fi direct (collectively referred to herein as Wi-Fi). IVI 338 can any suitable systems for providing information and entertainment to occupants of a vehicle. An IVI 338 can include GPS circuits 322 and a user interface (IF) 338-0. GPS circuits 322 can receive GPS signals and determine a current location of a vehicle. A user IF 338-0 can include any suitable system, including but not limited to, a touchscreen, heads-up display, or other display, buttons, audio system, or warning indicators (visual, audio or tactile).

Configurable vehicle systems (324-0 to -4) can include, but are not limited to, any suitable systems of a vehicle that can control physical operations of a vehicle, sense a state of a vehicle and/or sense an environment of a vehicle. In the embodiment shown, ADAS 324-0 can be in communication with, and/or control, various sensors, including lidar 324-00, radar (short range and/or long range) 324-01, camera(s) 324-02 and/or ultrasound sensors 324-03. Suspension control 324-1 can control suspension settings of a vehicle, including but not limited to, adjusting leveling, damping and/or travel limits of suspension components. ABS/anti-slip 324-2 can control wheel rotation according to any suitable manner, including but limited to, applied torque and/or applied brake (regenerative and/or conventional). TPMS 324-3 can wirelessly receive tire data from tire sensors 324-30 and transmit configuration data to configure tire sensors 324-30. An ECU 324-4 can control various operations of the vehicle, including but not limited speed (maximum, minimum) and/or acceleration.

A signal fabric 320 can include any suitable data transmission systems of a vehicle, including but not limited to, wireless systems (e.g., BT, Wi-Fi, Zigbee) and/or wired systems (e.g., CAN-type bus, media oriented systems transport (MOST), Flexray or Automotive Ethernet).

Referring still to FIG. 3, an operation of system 304 will now be described. TCU 318 can receive an event notification packet 334. Such a packet can be received by any suitable wireless circuit. An event notification packet 334 can be received automatically from another system (i.e., pushed) or can be requested by a vehicle (i.e., pulled). An event notification packet 334 can include event data 340, that can be provided to processing circuits 316 over signal fabric 320. Event data 340 can include any suitable data describing an event, as described herein and equivalents, including an event location.

From received event data 340, processing circuits 316 can determine a proximity to an event 326. In some embodiments, such an operation can use location data 342 from GPS circuits 322. A proximity to an event can vary according to event type or other conditions as described herein. Also in response to event data 340, processing circuits 318 can generate vehicle settings 336. Vehicle settings 336 can vary as described herein, or equivalents, including varying according to event type, event severity, and/or local conditions. Vehicle settings 336 can also include warnings for occupants of a vehicle. Dynamic vehicle settings control 328 can transmit vehicle settings to various systems (324-0 to -4) over signal fabric 320. Such settings can be transmitted when the vehicle is in proximity to an event, with sufficient time for systems (324-0 to -4) to adjust to the event. In some embodiments, such vehicle settings can be generated and transmitted automatically. In other embodiments, all or a portion of the vehicle settings can be activated with user input.

Processing circuits 316 can take any suitable form, including processors, microprocessors, microcontroller, and custom logic (both fixed and programmable). Processing circuits 316 can include, or work in conjunction with, memory circuits, including memory circuits storing code for execution.

Vehicle settings generated in response to an event can include, but are not limited to, changes in sensor sample rate and/or sensor direction 334-0 for ADAS 324-0, changes in leveling, damping or travel for suspension control 324-1, changes in rotation limits for ABS/anti-slip system 324-2, changes in sample rate (e.g., for tire pressure) 334-3 for TPMS node 324-3 and/or changes in speed 334-4 for ECU 324-4. In addition, a warning 344 can be provided to, and output from, user IF 338-0. When a vehicle is determined to no longer be in proximity of an event, dynamic vehicle settings control 328 can return systems (324-0 to -4) to previous states and/or readjust such systems to current conditions.

In this way, processing circuits of a vehicle can receive event data via a wireless system, including an event location. Processing circuits 326 can determine when the vehicle is within proximity to the event, and then generate vehicle settings to adjust vehicle performance for the event. Vehicle settings can be applied to various vehicle systems over wireless connections, wired connections, and combinations thereof.

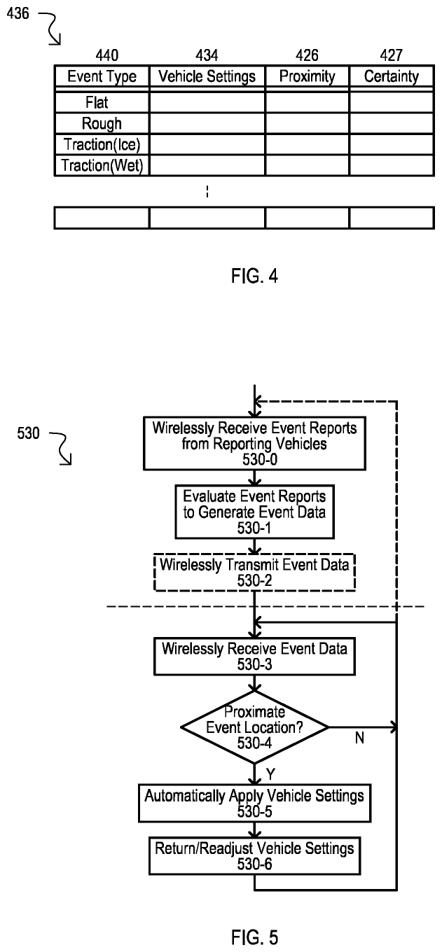

FIG. 4 is a table showing a generation of vehicle settings 436 according to an embodiment. Event data 440 received in an event notice can indicate an event type. From an event type, processing circuits can generate vehicle settings 434, which can take the form of any of those described herein, or equivalents. Also from an event type, processing circuits can determine a proximity 426 for the event, which can take the form of any of those described herein, or equivalents. A certainty value 427 can indicate how certain the event is. In some embodiments, the more event notices that indicate an event, the higher a certainty value 427 can be. In some embodiments, an event may need a certainty value over a predetermined threshold to be included in an event notice reported to other vehicles or indicated on a map.

FIG. 4 shows various examples of possible events (flat, rough, traction (ice), traction (wet)). However, such events should be considered exemplary, as one skilled the art would recognize road events can encompass any other suitable events/conditions in which an adjustment of vehicle settings prior to the event can help reduce any adverse effects that may arise from the event.

In some embodiments, vehicle settings and/or proximity values can be generated by arithmetic logic operations of processing circuits. However, alternate embodiments can have sets of vehicle settings stored memory circuits that are accessed according to a vehicle type. Still further, vehicle settings can be generated by a machine learning system, as described herein, or an equivalent.

While vehicle settings and/or proximity values can be generated by processing circuits of a vehicle, in other embodiments such values can be generated by processing circuits of a remote computing system and provided to a vehicle in an event notice.

In this way, a vehicle system can generate vehicle settings and a proximity value in response to an event type data received in a wireless transmission. A proximity value can indicate a point at which vehicle settings can be applied in anticipation of the indicated event.

FIG. 5 is a flow diagram of a method 530 according to another embodiment. A method 530 can include wirelessly receiving event reports from reporting vehicles 530-0. Event reports can be evaluated to generate event data 530-1. Event data can include any event data as described herein or equivalents, including but not limited to, an event location, event type, event severity, vehicle settings or event proximity value. Optionally, a method 530 can include wirelessly transmitting event data 530-2.

A method 530 can include wirelessly receiving event data 530-3. A determination can be made as to when a vehicle is within proximity of an event 530-4. While a vehicle is not within proximity of an event (N from 530-4), a method can continue to wirelessly receive event data 530-3, or optionally, return to receiving event reports 530-0.

When a vehicle is within proximity of an event (Y from 530-4), a method can automatically apply vehicle settings 530-5. Subsequently, vehicle settings can be returned to previous values (i.e., values prior to the event) and/or readjusted for current conditions 530-6.

In some embodiments, a method 530 can be distributed between one or more systems. In some embodiments, actions 530-0 to 530-2 can be performed by a remote computing system, while actions 530-3 to 530-6 are performed by a target vehicle (e.g., a vehicle receiving event data). However, in other embodiments, actions 530-0/1/3/4/5/6 can be performed by a same vehicle system. In such an embodiment, a vehicle can be in communication with other vehicles in a same geographic region (e.g., peer-to-peer vehicle network), and receive and process event notices from such other vehicles.

In this way, a method can include applying vehicle settings in response to being proximate a road event, where the occurrence of the road event can be determined by the vehicle, or by a system remote from the vehicle.

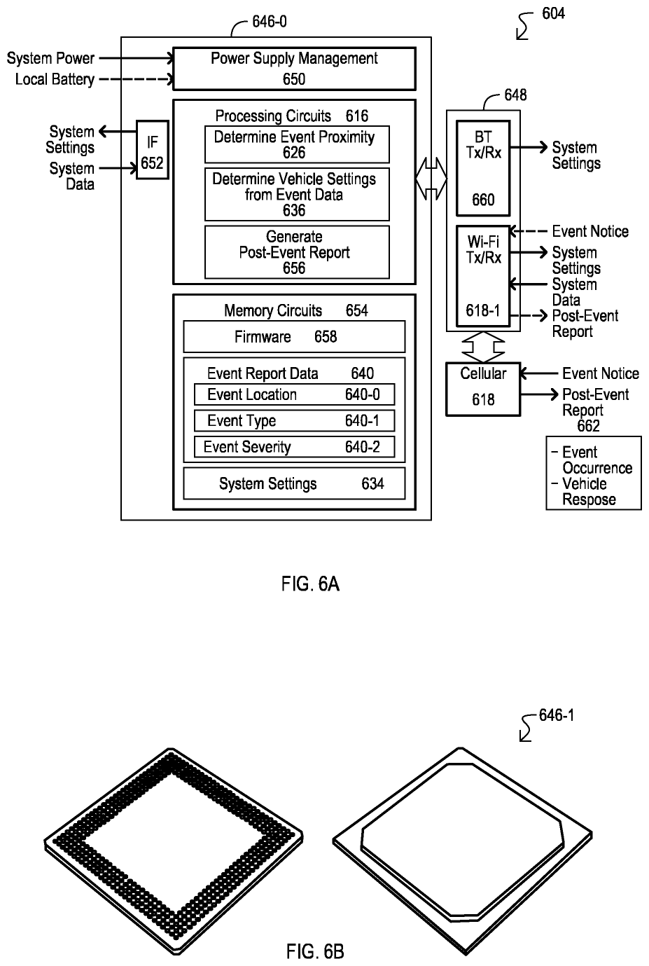

FIG. 6A is a block schematic diagram of an automobile system 604 according to another embodiment. A system 604 can include a controller device 646-0, communication device 648, and cellular circuits 618. In some embodiments, a controller device 646-0 can be a unitary integrated circuit device, including but not limited to a microcontroller, microprocessor or system-on-chip (SoC), including a programmable SoC. A controller device 646-0 can include power supply management circuits 650, processing circuits 616, memory circuits 654 and wired interface (IF) circuit 652. Processing circuits 616 can take any suitable form, as described herein and equivalents. Processing circuits 616 can determine event proximity 626, determine vehicle settings 636 and can generate post-event report 656. Determining event proximity 626 and vehicle settings 636 can take the form of any of those described herein or equivalents. Generating post-event report 656 can include receiving data from vehicle systems before, during and/or after a vehicle experiences the event, and generating data for transmission indicating a vehicle state following an event.

Memory circuits 654 can store data for executing processing circuit operations as described herein, including but not limited to, firmware 658, event report data 640 and system settings 634. Firmware 658 can include code executable by one or more processors in processing circuits 616 for providing the operations described herein. Event report data 640 can include an event location 640-0, an event type 640-1 and event severity 640-2. System settings 634 can be values generated by processing circuits 616 with operation 636.

A communication device 648 can include BT circuits 660 and Wi-Fi circuits 618-1, which can wirelessly communicate with other devices/systems of a vehicle, as well as devices external to a vehicle. BT circuits 660 can transmit system settings to any suitable system of vehicle, including BT compatible tire sensors, as well as receive system data from vehicle systems. Wi-Fi circuits 618-1 can transmit system settings to any suitable vehicle systems. Optionally, Wi-Fi circuits 618-1 can receive event notices and/or transmit post-event reports. In some embodiments, a communication device 648 can be a unitary integrated circuit device. However, in other embodiments, communication device 648 can be part of (e.g., formed in the same integrated circuit device as) controller device 646-0.

Cellular circuits 618 can receive event notices and transmit post-event reports 662 over a cellular network to a remote computing system. A post-event report 662 can include event occurrence data (e.g., event did or did not occur) as well as vehicle response data. However, a post-event report 626 can include any other suitable data related to an event, including particular sensor data (e.g., camera or radar data). As in the case of communication device 648, cellular circuits 618 can a unitary integrated circuit device or part of controller device 646-0. Cellular circuits 618 can also be part of communication device 648.

FIG. 6B includes two different views of a controller device 646-1 according to an embodiment. A controller device 646-1 can include circuits like those shown in 646-0 of FIG. 6A, and can be in the form of a single integrated circuit device. While FIG. 6B shows a packaged IC device, alternate embodiments can include a different type of packaging and/or an unpackaged die attached to systems substrate in any suitable fashion.

In this way, a vehicle system can include a controller device that receives event notice data over wireless connections, and in response, generates and output vehicle system settings.

While embodiments can include the various methods described in conjunction with vehicle system and described herein, additional methods will now be described with reference to flow diagrams.

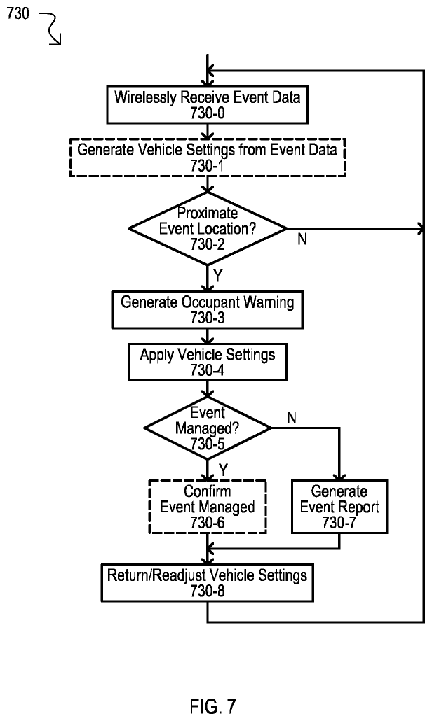

FIG. 7 is a flow diagram of a method 730 according to an embodiment. In some embodiments, a method 730 can be executed by a vehicle system. A method 730 can include wirelessly receiving event data 730-0. Such an action can include receiving a communication that includes event data according to one or more wireless standard. In some embodiments, such an action can include receiving an event notice packet via a cellular network, as described herein. Received event data can include an event location. Optionally, a method 730 can include generating vehicle settings from event data 730-1. Such an action an include any of those described herein, or equivalents, that generates vehicle settings for controlling various systems of a vehicle. However, in alternate embodiments event data can include vehicle settings.

A method 730 can determine if a vehicle is within proximity to an event location 730-2. Such an action an include any of those described herein, or equivalents. If a vehicle is not within proximity of an event (N from 730-2), a method 730 can return to wirelessly receiving event data 730-0. If a vehicle is determined to be within proximity of an event (Y from 730-2), a method 730 can generate an occupant warning 730-3 and apply vehicle settings 730-4. Such actions can include any of those described herein or equivalents. As understood from embodiments herein, such actions can be automatically executed by the vehicle, may involve a user input (e.g., user authorizes application of vehicle settings), or a combination thereof. Applied vehicle settings can have been generated as indicated in action 730-1, or can have been received as event data in 730-0.

A method 730 can then determine if an event has been managed 730-5. Such an action can include monitoring vehicle data, and take any suitable form. In one embodiment, if a vehicle has moved beyond the proximity of an event location, it can be determined to have managed the event. However, in other embodiments, a response of one or more systems can determine if an event has been managed. As but a few of many possible examples, tire pressure can be monitored to determine if there is any significant pressure loss over time. Speed can be monitored to determine if speed has not remained within a predetermined range or other expected behavior. Wheel rotation, or anti-lock/anti-slip systems can be monitored to determine if wheel slip was managed. However, these limited examples should not be construed as limiting. One skilled in the art would realize any appropriate vehicle system can be monitored in a variety of ways to make such a determination.

If an event was determined not to be managed (N from 730-5), a method can generate an event report 730-7. Such an action can include wirelessly transmitting post-event data to a remote system. Post-event data can include any suitable data characterizing a vehicle interaction with the event. Post-event data can include vehicles sensor data (prior to event, during event and/or after event), vehicle analysis of sensor data, or combinations thereof. In some embodiments, post-event data can include some or all of the vehicle settings that were applied when in proximity to the event. If an event was determined to be managed (Y from 730-5), optionally, a method can generate a confirmation that the event was managed 730-6. Such an action can include wirelessly transmitting a message to a remote system. In some embodiments, an event managed confirmation can include any of the data noted for the event report of 730-7.

A method 730 can return or readjust vehicle settings 730-8. Such an action can include any of those described herein, or equivalents.

In this way, a method can include wirelessly receiving event data, determining when a vehicle is with a proximity to the event, generating and occupant warning and applying settings to systems of the vehicle. Following the event, any of various reports related to the event can be wirelessly transmitted to a remote system.

While embodiments can include vehicle systems that receive event notices, other embodiments can include remote computing systems that generate event notices.

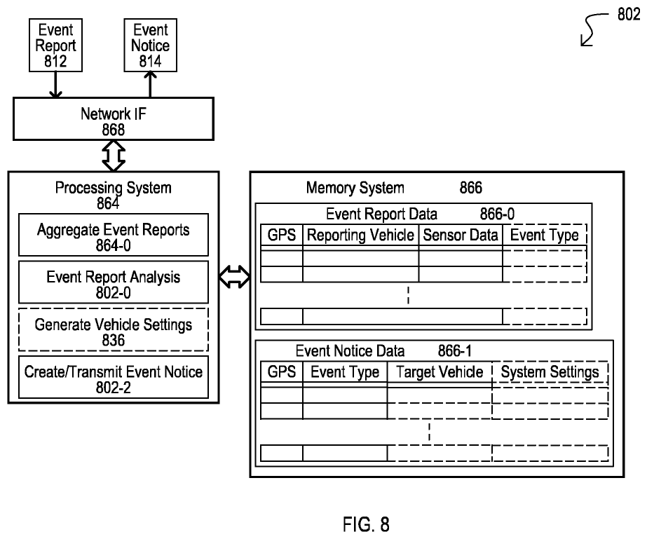

FIG. 8 is a block diagram of a remote computing system 802 according to an embodiment. A remote computing system 802 receive event reports from various vehicles, and in response, generate event notices for other vehicles to assist such vehicles in traversing the event. Such assistance can include, but is not limited to, providing an event type and/or system settings for a vehicle. A remote computing system 802 can include a processing system 864, a memory system 866 and a network IF 868.

A processing system 864 can execute various operations, including but not limited to, aggregating event reports 864-0, analyzing event reports 802-0 and creating and transmitting event notices 802-2. Optionally, processing system 864 can generate vehicle settings 836. Aggregating event reports 864-0 can include receiving multiple event reports 812 over a network IF 868 from reporting vehicles. Aggregating event reports 864-0 can include, but is not limited to, collecting event reports for a same geographic area and time. Event report analysis 802-0 can include, but is not limited to, determining a type of event at a location from data in the corresponding aggregated event reports 812. This can include analyzing raw sensor data included in event reports, analyzing a type of event as determined by a reporting vehicle, or combinations thereof. Creating and transmitting an event notice 802-2 can include creating a packet with event data and outputting such a packet via network IF 868. In some embodiments, creating and transmitting an event notice 802-2 can include receiving requests from target vehicles, and returning event notice data in response. In some embodiments, event notice data can be integrated into map and/or route data for a vehicle.

Generating vehicle settings 836 can include, but is not limited to, determining a type of event, determining a target vehicle, and generating system setting for a target vehicle according to an event type. Such system setting can then be included in an event notice 814.

A memory system 866 can provide memory of any suitable type to a processing system 864. A memory system 866 can event report data (one example set shown as 866-0) and event notice data (one example set shown as 866-1).

In the embodiment shown, event report data 866-0 can include GPS data, reporting vehicle data, sensor data and optionally, event type data. GPS data can indicate an event location as determined by a reporting vehicle. Reporting vehicle data can indicate a type of reporting vehicle. In some embodiments, such data can be anonymized (e.g., indicate a general type of vehicle, or not identify vehicle at all). Sensor data can include sensor data acquired by a reporting vehicle related to the reported event. Optionally, a reporting vehicle may have analyzed its own sensor data and made a determination as to the type of event. In such a case, an event type can be included in event report data.

In the embodiment shown, event notice data 866-1 can include GPS data, event type data, and optionally, a target vehicle and system settings data. GPS data can identify a location of an event. An event type can be generated by a processing system 864 analyzing aggregated event reports. Target vehicle data can identify vehicle(s) that are to receive an event notice 814. Target vehicle data can include any suitable data, including a type of vehicle. System settings data can be generated by processing system 864 in response to an event type and target vehicle data. System settings data can take the form of any of those described herein or equivalents. As noted above, event notice data 866-1 can be included with map and/or route data provided to vehicles. Such an arrangement can include a remote system 802 providing event notice data 866-1 to a mapping/routing service, and such a service integrating such data into its mapping/routing data.

A network IF 868 can receive event reports 812 and transmit event notices 814 to one or more wireless networks.

In this way, a remote computing system can include a processing system that aggregates and analyzes event reports from reporting vehicles to generate event notice data. Event notice data can be transmitted to other vehicles to enable such other vehicles to adjust system settings in anticipation of the event.

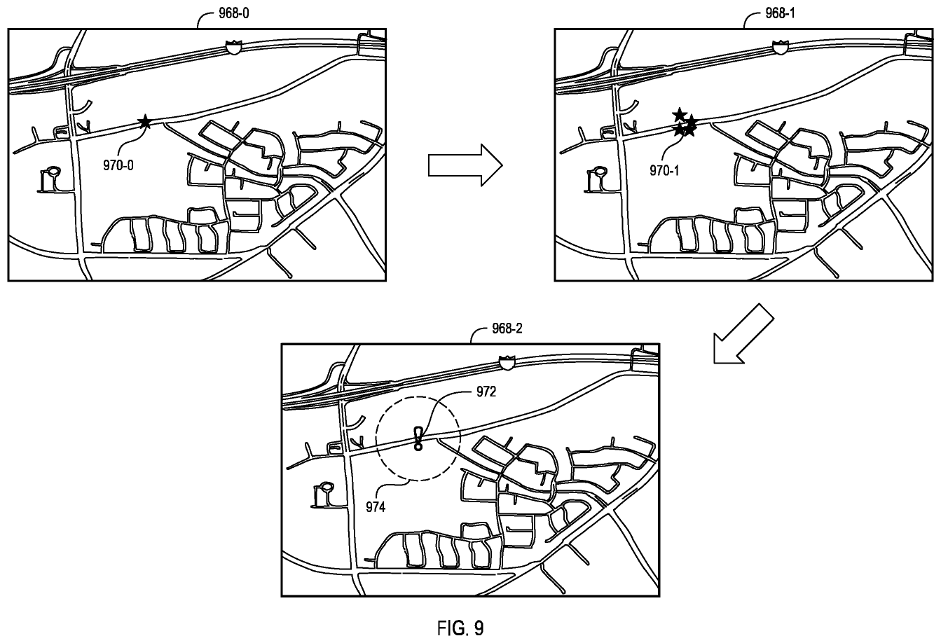

FIG. 9 shows methods and corresponding map/routing data according to an embodiment. FIG. 9 shows the evolution of map/routing data in response to reported events according to an embodiment. FIG. 9 shows initial map data 968-0. Initial map data 968-0 can include data for one or more event reports 970-0. However, an analysis of event report(s) 970-0, as performed by a remote computing system or a vehicle, has determined an event of sufficient severity does not exist and/or there is not sufficient data to determine an event exists.

Intermediate map data 968-1 shows the aggregation of event reports 970-1. An aggregation of event reports 970-1 can result from multiple event reports being received that correspond to a same location and optionally, include event data indicating a same type of event.

Event reporting map data 968-2 shows a result of an event report being integrated with map data. A location of an event 972 can be identified on a map. In addition, by operation of processing circuits on a vehicle and/or a remote computing system, an event proximity 974 can be determined. When a vehicle enters an event proximity 974 adjustments and/or warnings can be made to the vehicle as described herein or equivalents.

In this way, event reports received from vehicles can be used to determine a proximity to an event location with respect to vehicle mapping/routing data, to enable a vehicle to adjust settings and/or warn occupants prior to experiencing the event.

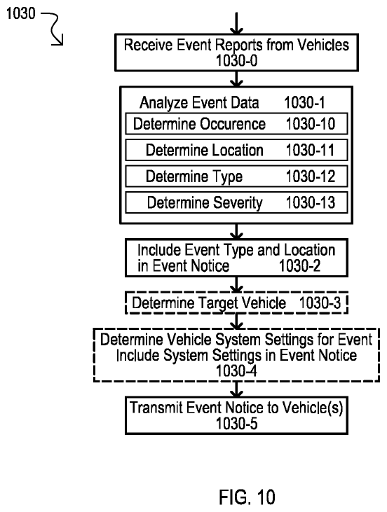

FIG. 10 is a flow diagram of a method 1030 according to a further embodiment. In some embodiments, a method 1030 can be executed by a remote computing system. A method 1030 can include receiving event reports from vehicles 1030-0. Such an action can include any of those described herein or equivalents.

Event data can be analyzed 1030-1. In the embodiment shown, analyzing event data can 1030-1 include determining occurrence 1030-10, determining location 1030-11, determining type 1030-12 and determining severity 1030-13. Determining occurrence 1030-10 can determine when an event is to be reported by an event notice, and can include, but is not limited to, aggregating event reports, evaluating the persistence of event reports at a location, weighting event reports based on severity indicated in the event report, and/or weighting ever reports based on a reporting vehicle. Determining a location 1030-11 can include determining a location of a reported event. In some embodiments, such an action can be based on event report locations and/or data provided in event reports (e.g., camera data transposed to map/route data). Determining a type 1030-12 can include determining a type of event. Such an action can include analyzing sensor data received in event reports (e.g., camera data, tire pressure data). Determining a severity 1030-13 can include determining a severity of an event. Such an action can also include analyzing sensor data received in event reports.

An event type and event location can be included in an event notice 1030-2, and an event notice can be transmitted to one or more vehicles 1030-5. Such actions can include any of those described herein, or equivalents.

Optionally, a method 1030 can include determining a target vehicle 1030-3. Such an action can include determining a type of target vehicle(s) near an event location. Such a determination can result in a data identifying the systems of a target vehicle that can be adjusted by application of system settings. Having determined a target vehicle, a method 1030 can determine vehicle system settings for the target vehicle based on event data (e.g., data in event reports), and include such system settings in an event notice 1030-4.

In this way, a method can receive event reports and analyze event data included within such event reports to determine if an event has occurred, a location of the event, the type of event and a severity of the event.

Embodiments can generate vehicle system settings to assist vehicles in encounters with road events in any suitable fashion. In some embodiments, vehicle data from vehicles that have successfully traversed a road event can be used in machine learning systems to train a statistical model to generate system settings from vehicle data.

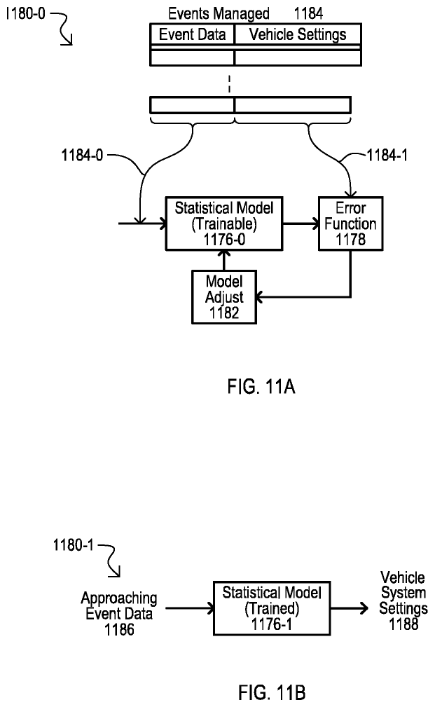

FIGS. 11A and 11B are diagrams of a machine learning system that can generate system settings for detected road events. FIG. 11A shows a system 1180-0 that can include a trainable statistical model 1176-0, error function 1178, model adjust 1182 and training data 1184. A trainable statistical model 1176-0 can include any suitable model including an artificial neural network. An error function 1178 can determine an error between a training data set input and training data set output. A model adjust 1182 can adjust model 1176-0 in response to error data. A model adjust 1182 can include any suitable machine learning operation (e.g., back propagation of neuron weights). Training data 1184 can include data for vehicles that have successfully traversed various event types. Training data 1184 can include input event data 1184-0 that can characterize an event. Event data can include any of those described herein, or equivalents, including but not limited to, an event type, event location, or event severity. Training data 1184 can also include output vehicle settings 1184-1, that can include any of those described herein, or equivalents. In some embodiments, training data 1184 can be data for a same type or class of vehicle.

FIG. 11B is a diagram of a trained system 1180-1 according to an embodiment. A system 1180-1 can be implemented on a vehicle and/or a remote computing system. A system 1180-1 can include a trained statistical model 1176-1, which can be a model like that shown in FIG. 11A after the model has been trained with the training data. In response to event data on an approaching event 1186 (e.g., an event indicated in an event notice), a trained model 1176-1 can generate (e.g., infer) a set of system settings 1188. Such system settings 1188 can be applied to vehicle once it is in proximity to the approaching event, as described herein or equivalents.

In this way, machine learning can be used to generate vehicle system settings in response to event data.

Embodiments can include methods, devices and systems that include processing circuits configured to receive event data from wireless circuits, including an event location. Processing circuits can determine when a vehicle is within a predetermined proximity of the event location, and in response to being within proximity of the event location, generate vehicle settings particular to the event data. Vehicle settings can be configured to adjust the operation of at least one vehicle system. Processing circuits can transmit vehicle settings over a device interface.

Embodiments can include methods, devices and systems can include a vehicle system having wireless circuits configured to receive event data, including an event location and processing circuits configured to determine when a vehicle is within a predetermined proximity of the event location, and, in response to being within proximity of the event location, generate vehicle settings particular to the event data. At least one vehicle system ca be in communication with the processing circuits and configured to adjust its operation in response to the vehicle settings.

Methods, devices, and systems according to embodiments can include event data including an event type, and determining when the vehicle is within proximity of the event location includes establishing proximity in response to any selected from the group of: the event type, map data, and vehicle state data.

Methods, devices, and systems according to embodiments can include at least one system of the vehicle being selected from the group of: a wheel anti-slip system, anti-lock brake system, vehicle speed control system, and a vehicle sensor system.

Methods, devices, and systems according to embodiments can include, the event data including vehicle settings, and automatically adjusting at least one system of the vehicle in response to the vehicle settings.

Methods, devices, and systems according to embodiments can include the event data including an event type. Vehicle settings can be generated in response to at least the event type. At least one system of the vehicle can be automatically adjusting in response to the vehicle settings.

Methods, devices, and systems according to embodiments can include, after determining the vehicle has traversed the event, transmitting an event report by operation of the wireless circuits. The event report can include data recorded by the vehicle.

Methods, devices, and systems according to embodiments can include determining if the event occurred, and, in response to determining that the event did not occur, transmitting a non-event report by operation of the wireless circuits.

Methods, devices, and systems according to embodiments can include processing circuits configured to, in response to being within proximity of the event location, generating occupant warning data, and transmitting the occupant warning data over the device interface.

Methods, devices, and systems according to embodiments can include vehicle settings being included in event data.

Methods, devices, and systems according to embodiments can include a device interface that includes a bus interface compatible with a vehicle bus selected from the group of: a CAN-type bus, media oriented systems transport (MOST), Flexray and Automotive Ethernet.

Methods, devices, and systems according to embodiments can include a device interface that includes wireless circuits compatible with a wireless standard selected from the group of: a Bluetooth standard, a Zigbee standard, and an IEEE 802.11 wireless standard.

Methods, devices, and systems according to embodiments can include event data having an event identification and severity value. Processing circuits can be configured to generate different vehicle settings for event data having a same event identification but with different severity values.

Methods, devices, and systems according to embodiments can include a vehicle system that includes a user interface. Processing circuits can be configured to generate a warning via the user interface in response to being within proximity of an event location.

Methods, devices, and systems according to embodiments can include an event location including event GPS data. A vehicle system can include GPS circuits configured to generate vehicle location data. Processing circuits can be configured to determine when the vehicle is within the predetermined proximity using the event GPS data and vehicle location data.

Methods, devices, and systems according to embodiments can include at least one remote computing system coupled to a wireless network and configured to generate and transmit the event data.

Methods, devices, and systems according to embodiments can include at least one remote computing system configured to receive event reports from a plurality of other vehicles, determine the occurrence of an event from the event reports, and generate the event data for the event using the event reports.

Methods, devices, and systems according to embodiments can include at least one remote computing system coupled to a wireless network and configured to generate and transmit event data.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method, comprising:
by operation of wireless circuits of a vehicle, wirelessly receiving event data, including an event location;
by operation of processing circuits of the vehicle, determining when the vehicle is within a predetermined proximity of the event location;
in response to the vehicle being within proximity of the event location, automatically adjusting at least one system of the vehicle according to at least the event data; and
in response to the vehicle moving beyond the event location, returning the at least one system to a previous data or readjusting the at least one system.

2. The method of claim 1, wherein:
the event data includes an event type; and
determining when the vehicle is within proximity of the event location includes establishing proximity in response to any selected from the group of: the event type, map data, and vehicle state data.

3. The method of claim 1, wherein the at least one system of the vehicle is selected from the group of: a wheel anti-slip system, anti-lock brake system, vehicle speed control system, and a vehicle sensor system.

4. The method of claim 1, further including, in response to the vehicle being within proximity of the event location, generating a warning for occupants of the vehicle.

5. The method of claim 1, wherein:
the event data includes vehicle settings; and
automatically adjusting the at least one system of the vehicle in response to the vehicle settings.

6. The method of claim 1, further including:
the event data includes an event type;
generating vehicle settings in response to at least the event type; and
automatically adjusting the at least one system of the vehicle in response to the vehicle settings.

7. The method of claim 1, further including after determining the vehicle has traversed the event, transmitting an event report by operation of the wireless circuits, the event report including data recorded by the vehicle.

8. The method of claim 1, further including:
determining if the event occurred; and
in response to determining that the event did not occur, transmitting a non-event report by operation of the wireless circuits.

9. A device, comprising:
processing circuits configured to
receive event data from wireless circuits, including an event location,
determine when a vehicle is within a predetermined proximity of the event location,
in response to being within proximity of the event location, generate vehicle settings particular to the event data, the vehicle settings configured to adjust the operation of at least one vehicle system, and
transmitting the vehicle settings over a device interface.

10. The device of claim 9, wherein:
the processing circuits are further configured to
in response to being within proximity of the event location, generating occupant warning data, and
transmitting the occupant warning data over the device interface.

11. The device of claim 9, wherein the vehicle settings are included in the event data.

12. The device of claim 9, further including the device interface comprises a bus interface compatible with a vehicle bus selected from the group of: a CAN-type bus, media oriented systems transport (MOST), Flexray and Automotive Ethernet.

13. The device of claim 9, wherein the device interface comprises wireless circuits compatible with a wireless standard selected from the group of: a Bluetooth standard, a Zigbee standard, and an IEEE 802.11 wireless standard.

14. A system, comprising:
a vehicle system that includes
wireless circuits configured to receive event data, including an event location;
processing circuits configured to
determine when a vehicle is within a predetermined proximity of the event location, and
in response to being within proximity of the event location, generate vehicle settings particular to the event data; and
at least one vehicle system in communication with the processing circuits and configured to adjust its operation in response to the vehicle settings.

15. The system of claim 14, wherein:
the event data further includes an event identification and severity value; and
the processing circuits is further configured to generate different vehicle settings for event data having a same event identification but with different severity values.

16. The system of claim 14, wherein:
the vehicle system further includes
a user interface,
the processing circuits are further to generate a warning via the user interface in response to being within proximity of the event location.

17. The system of claim 14, wherein:
the event location comprises event global position system (GPS) data; and
the vehicle system further includes
GPS circuits configured to generate vehicle location data, and
the processing circuits are configured to determine when the vehicle is within the predetermined proximity using the event GPS data and vehicle location data.

18. The system of claim 14, further including at least one remote computing system coupled to a wireless network and configured to generate and transmit the event data.

19. The system of claim 14, further including:
at least one remote computing system configured to
receive event reports from a plurality of other vehicles,
determine the occurrence of an event from the event reports, and
generate the event data for the event using the event reports.

20. The system of claim 14, further including:
the vehicle system further includes
the event data comprising adverse event data and non-adverse event data;
a user interface; and
the processing circuits are further configured to indicate road conditions corresponding to the non-adverse event data on the user interface.
